(19) United States
(12) Patent Application Publication
(10) Pub. No.: US 2009/0228487 A1
(43) Pub. Date: Sep. 10, 2009

(54) Image forming apparatus and access control method

(75) Inventor: Eiichiro Yoshida, Kanagawa (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/379,853

(22) Filed: Mar. 3, 2009

(30) Foreign Application Priority Data
Mar. 5, 2008 (JP) 2008-054818

(51) Int. Cl. G06F 17/30

(52) U.S. Cl. 707/9; 707/E17.005

(57) ABSTRACT

An image forming apparatus is disclosed, including: a first data management part; a second data management part; and a determination part. The first data management part manages a list of first data concerning information regarded as a management unit. The second data management part manages a list of second data concerning accompanying information which accompanies with the information regarded as the management unit. The determination part determines allowing or denying an operation request based on access control information recorded in a first recording medium associating with the first data with which the second data accompanies, in response to the operation request with respect to the second data.

### BACKGROUND OF THE INVENTION

1. Field of the Invention

The present invention is related to an image forming apparatus and an access control method, and more particularly to the image forming apparatus and the access control method for conducting an access control with respect to management information.

2. Description of the Related Art

In general, a memory capacity mounted in an image forming apparatus is less than a general computer. However, in some image forming apparatuses, information (for example, documents (image) information) is divided into a plurality tables to be managed, so as to suppress an information amount to load at once. In detail, in a case of managing information by a document unit, instead of managing all information regarding each document in one table, the information of the document is divided and managed in a plurality of tables: a table for managing a list of documents regarded as a management unit, a table for managing various information (for example, a page, a thumbnail, and a like) pertaining to the document, and a like. According to this management formation, when a thumbnail image is necessary, a record registered in the table of the thumbnail is simply loaded. Thus, it is not required to load information of the page and the like which is excessive information, to a memory.

Conventionally, as disclosed in Japanese Patent Application No. 2005-038371, in a case of dividing the management information into the plurality of tables and managing the plurality of tables, access control information such as an ACL (Access Control List) and a like is associated with each record for each table.

However, in many cases, it is appropriate to apply the same access control to both parent information corresponding to a document regarded as a management unit and child information accompanying the document. A user allowed to access the parent information is also allowed to access the child information. In order to realize the access control, in a conventional configuration, it is required to make consistency of the access control information respectively associating with the parent information and the child information. Thus, there is a problem in that a significantly complicated process is required. Also, there is another problem in that a consumption amount of the memory is increased by the access control information, since the access control information is redundantly managed.

### SUMMARY OF THE INVENTION

The present invention solves or reduces one or more of the above problems.

In an aspect of this disclosure, there is provided an image forming apparatus, including: a first data management part configured to manage a list of first data concerning information regarded as a management unit; a second data management part configured to manage a list of second data concerning accompanying information which accompanies with the information regarded as the management unit; and a determination part configured to determine allowing or denying an operation request based on access control information recorded in a first recording medium associating with the first data with which the second data accompanies, in response to the operation request with respect to the second data.

### BRIEF DESCRIPTION OF THE DRAWINGS

In the following, embodiments of the present invention will be described with reference to the accompanying drawings.

FIG. 1 is a diagram illustrating an example of a hardware configuration of an image forming apparatus according to an embodiment of the present invention;

FIG. 2 is a diagram illustrating an example of a software configuration of the image forming apparatus according to the embodiment of the present invention;

FIG. 3 is a conceptual diagram illustrating a configuration example of a database according to the embodiment of the present invention;

FIG. 4 is a diagram illustrating a configuration example of the database in a first implementation variation;

FIG. 5 is a diagram illustrating an example of a data structure of the database in the first implementation variation;

FIG. 6 is a diagram illustrating an example of recording a document table to a recording medium which is accessible at high speed in the first implementation variation;

FIG. 7 is a diagram for explaining a document cache table in the first implementation variation;

FIG. 8 is a diagram illustrating an example of recording only access right data of a few of operation types to the document cache table in the first implementation variation;

FIG. 9 is a diagram illustrating an example of a data structure of recording only the access right data of a few of operation types to the document cache table in the first implementation variation;

FIG. 10 is a sequence diagram for explaining process steps when a data operation is requested in the first implementation variation;

FIG. 11 is a diagram illustrating a configuration example of the database in a second implementation variation;

FIG. 12 is a diagram illustrating example of a data structure in the database of the second implementation variation;

FIG. 13 is a diagram illustrating an example of recording an access right table to a recording medium which is accessible at high speed in the second implementation variation;

FIG. 14 is a diagram for explaining an access right cache table in the second implementation variation;

FIG. 15 is a diagram illustrating an example of recording only the access right data of a few of operation types to the access cache table in the second implementation variation;

FIG. 16 is a diagram illustrating an example of a data structure of recording only the access right data of a few of operation types to the access right cache table in the second implementation variation;

FIG. 17 is a sequence diagram for explaining process steps when a data operation is requested in the second implementation variation;

FIG. 18 is a diagram illustrating a configuration example of the access right cache table in a third implementation variation; and

FIG. 19 is a sequence diagram for explaining an entry deletion process for deleting from the access right cache table in the third implementation variation.

### DESCRIPTION OF THE PREFERRED EMBODIMENT

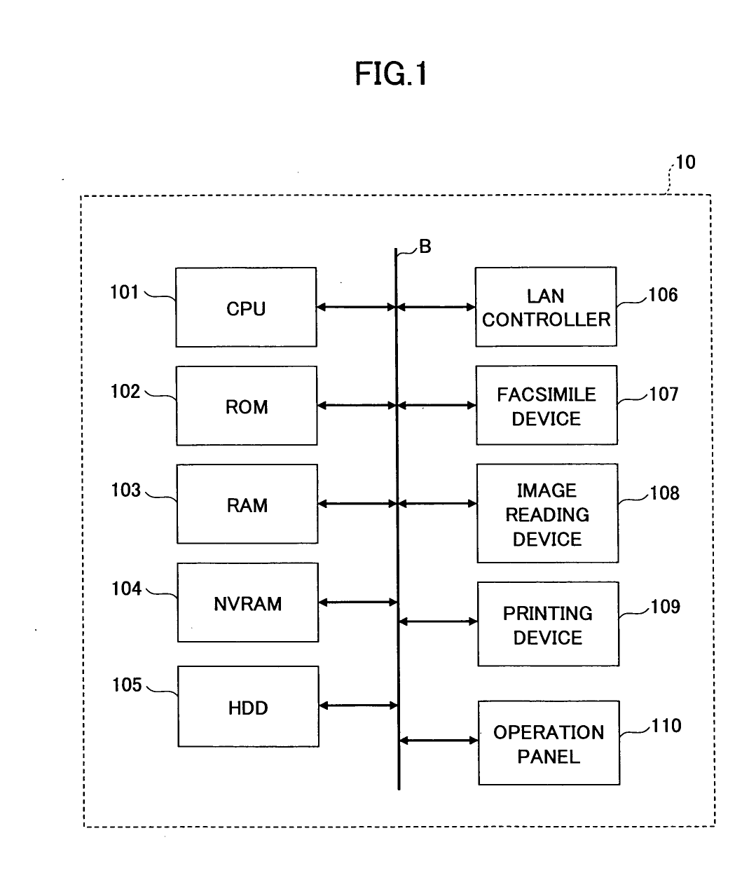

In the following, an embodiment of the present invention to will be described with reference to the accompanying drawings. FIG. 1 is a diagram illustrating an example of a hardware configuration of an image forming apparatus according to an embodiment of the present invention. As an example of the image forming apparatus 10, FIG. 1 illustrates a hardware configuration of a multi-functional apparatus realizing a plurality functions such as a printer, a copier, a scanner, a facsimile, and a like in a single chassis.

In FIG. 1, the image forming apparatus 10 includes a CPU (Central Processing Unit) 101, a ROM (Read-Only Memory) 102, a RAM (Random Access Memory) 103, NVRAM (Non-Volatile RAM) 104, an HDD (Hard Disk Drive) 105, a LAN (Local Area Network) controller 106, a facsimile device 107, an image reading device 108, a printing device 109, an operation panel 110, and a like, which are mutually connected to each other via a bus B.

The ROM 102, the NVRAM 104, the HDD 105, or the like stores various programs, data used by the various programs, and a like. The RAM 103 is used as a storage area used to load a program, a working area of the program being loaded, and a like. The CPU 101 realizes functions described later, by processing the program loaded in the RAM 103.

The LAN controller 106 realizes a communication through a network. The facsimile device 107 realizes facsimile sending and receiving functions. The image reading device 108 reads image data from a paper document. The printing device 109 prints the image data read by the image reading device 108, image data received through the network, and a like, on a printing paper. The operation panel 110 is hardware including buttons, a liquid crystal panel, and a like for accepting an input from a user, notifying information to the user, and a like.

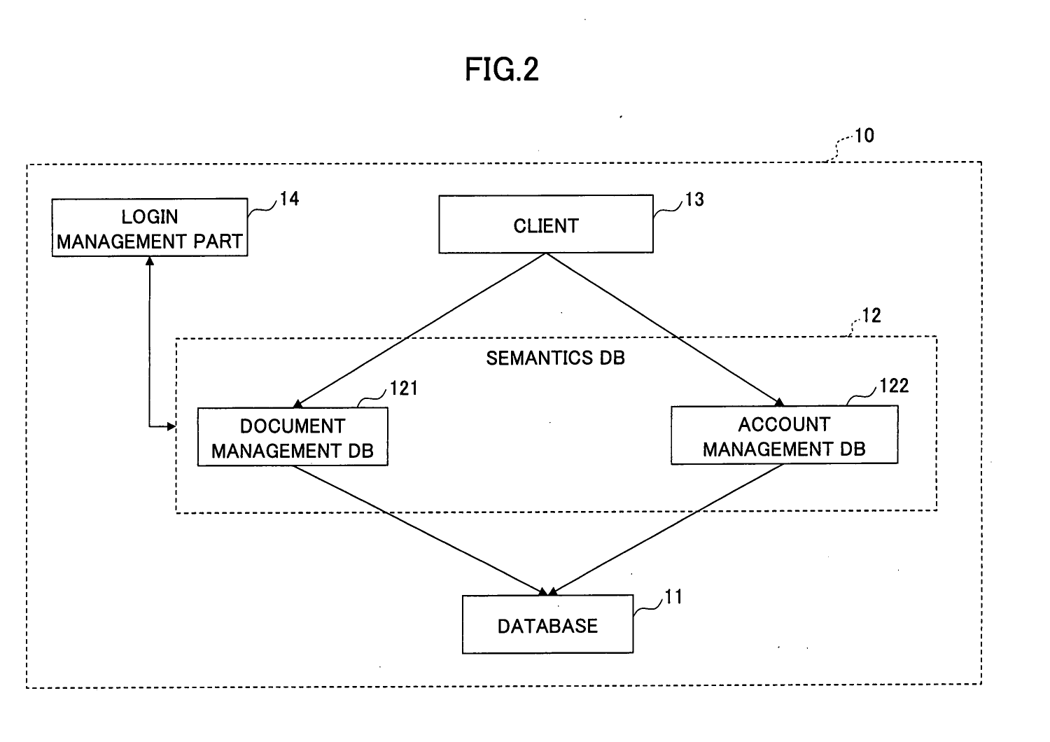

FIG. 2 is a diagram illustrating an example of a software configuration of the image forming apparatus 10 according to the embodiment of the present invention. In FIG. 2, the image forming apparatus 10 includes software functioning as a database 11, a semantics DB (DataBase) 12, a client 13, a login management part 14, and a like.

The database 11 is a so-called database engine, and systematically manages data subject to be managed in a predetermined format (for example, a spread sheet format such as a RDB (Relational Database). The semantics DB 12 interprets a meaning of data which are managed by the database 11. That is, the database 11 is just a “box” which manages data in accordance with a schema being defined beforehand. The semantics DB 12 recognizes a meaning of the data stored the “box” and a concept of the data. The semantics DB 12 makes the database 11 conduct data management corresponding to the concept and also provides an operation means (an operation interface) corresponding to the concept. In FIG. 2, as the semantic DB 12, a document management DB 121 and an account management DB 122 are illustrated. The document management DB 121 controls the database 11 to manage data concerning document information, and provides the operation means corresponding to the data to the client 13. The account management DB 122 controls the database 11 to manage data concerning account information of a user, and provides the operation means corresponding to the data.

The client 13 expresses the entire program which uses (operates) the semantics DB 12. The login management part 14 conducts an authentication for a user using the image forming apparatus 10 to log in, a management of a login state, and a like.

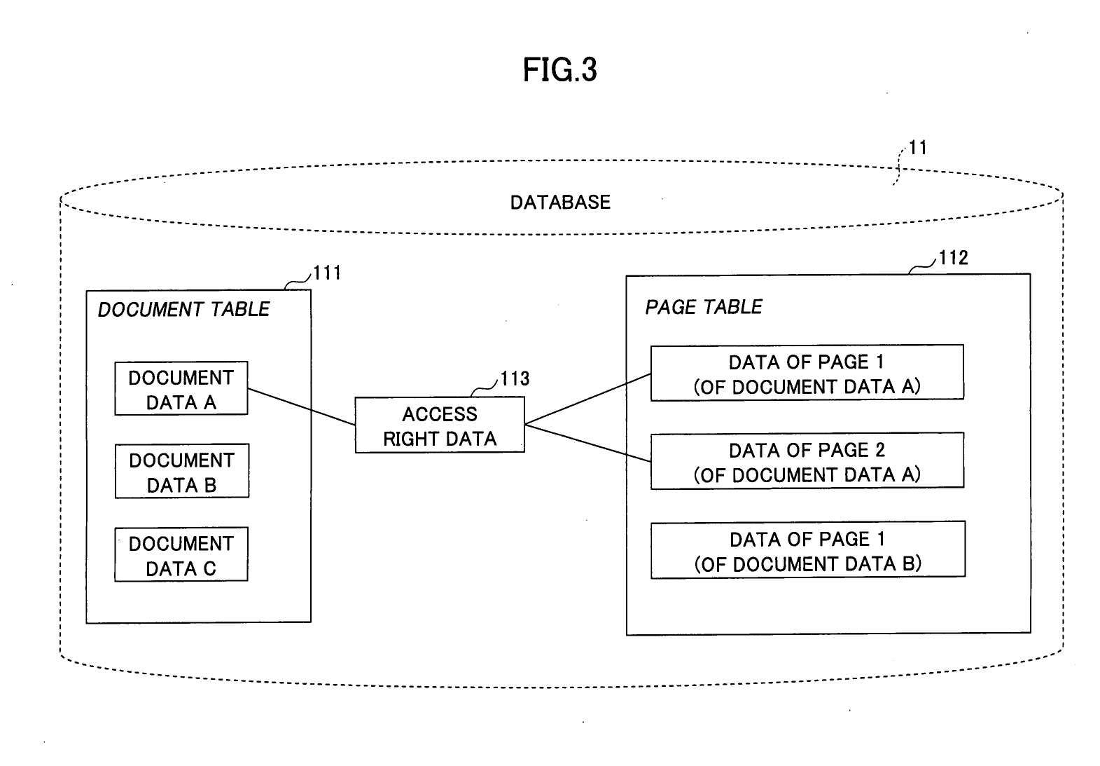

FIG. 3 is a conceptual diagram illustrating a configuration example of the database 11 according to the embodiment of the present invention. In FIG. 3, a management formation on the database 11 is conceptually depicted regarding the document information managed by the document management DB 121. In the embodiment, the document information is managed by two tables: a document table 111 and a page table 112. The document table 111 is a table for managing a list of data (sets of document data) expressing a document which is a maximum management unit of the document management DB 121. That is, the document management DB 121 stores data (a record) for each document. In FIG. 3, document data A, B, and C are illustrated within the document table 111.

The page table 112 is a table for managing a list of data (page data) concerning information for each page, as data accompanying or depending on a document. Accordingly, a plurality of sets of page data are associated with each set of document data A, B, and C of documents each including information of a plurality of pages.

In the management formation in which one set of the document information is divided into the plurality of tables, in the embodiment, access right data 113 is associated and shared with data (document data A, B, and C or page data) belonging to the same document information. The access right data 113 are data defining the access control information with respect to data as represented by the ACL (Access Control List).

That is, in this embodiment, instead of associating with the access control information for each set of data (each record) for each table (for example, for each set of document data A, B, and C and each set of page data), the access right data 113, which are defined with respect to parent data (document data) of the maximum management unit in information subject to be managed, are applied to child data (page data) accompanying (belonging to) the data. By applying this management formation regarding the access control information, it is possible to easily realize consistency of the access control between the parent data and the child data, and it also reduces a consumption of resources for storing the access control information.

In the following, implementations of the management formation of the access right data 113 conceptually illustrated in FIG. 3 will be described with separate examples in detail.

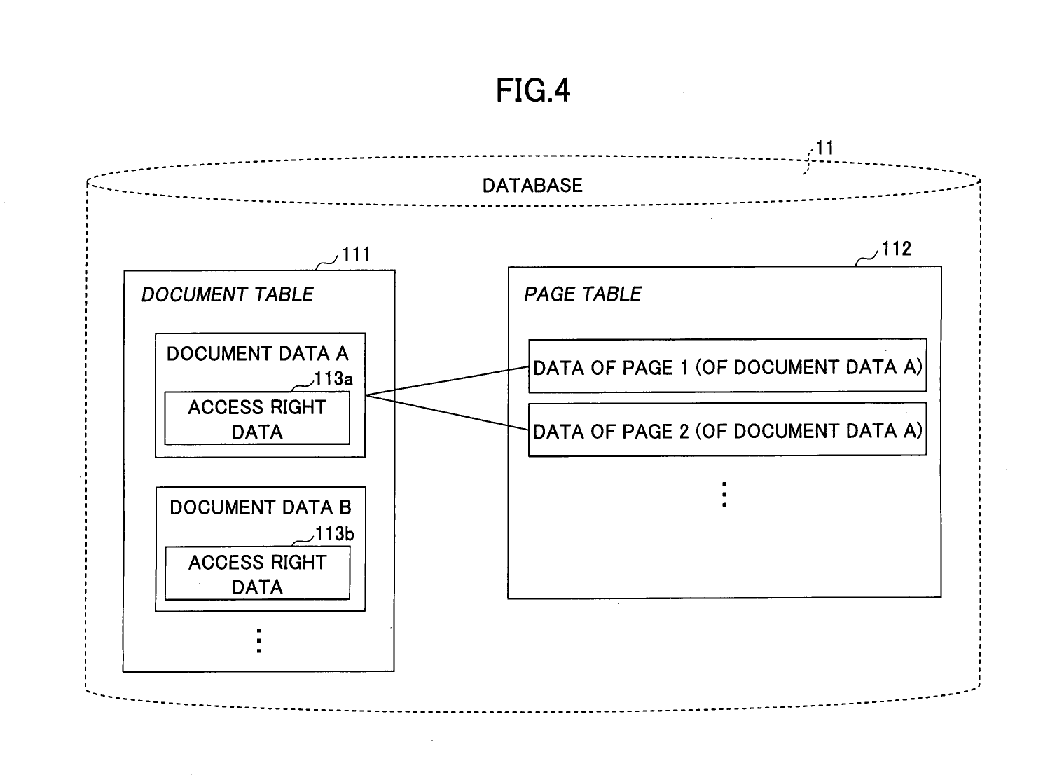

FIG. 4 is a diagram illustrating a configuration example of the database in a first implementation variation. In the first implementation variation as illustrated in FIG. 4, each set of the access right data 113 is included in each set of the document data A, B, and C. In FIG. 4, access right data 113a is included in the document data A, and access right data 113b is included in the document data B. The access right data 113 included in each set of the document data A, B, and C is applied to the page data belonging to the document data. In detail, the access right data 113a of the document data A are applied to data of page 1 (of the document data A) and data of page 2 (of the document data A).

In the first implementation variation, advantageously, it is possible to re-use the document table 111 which has existed, and it is also possible to simplify a design of a schema.

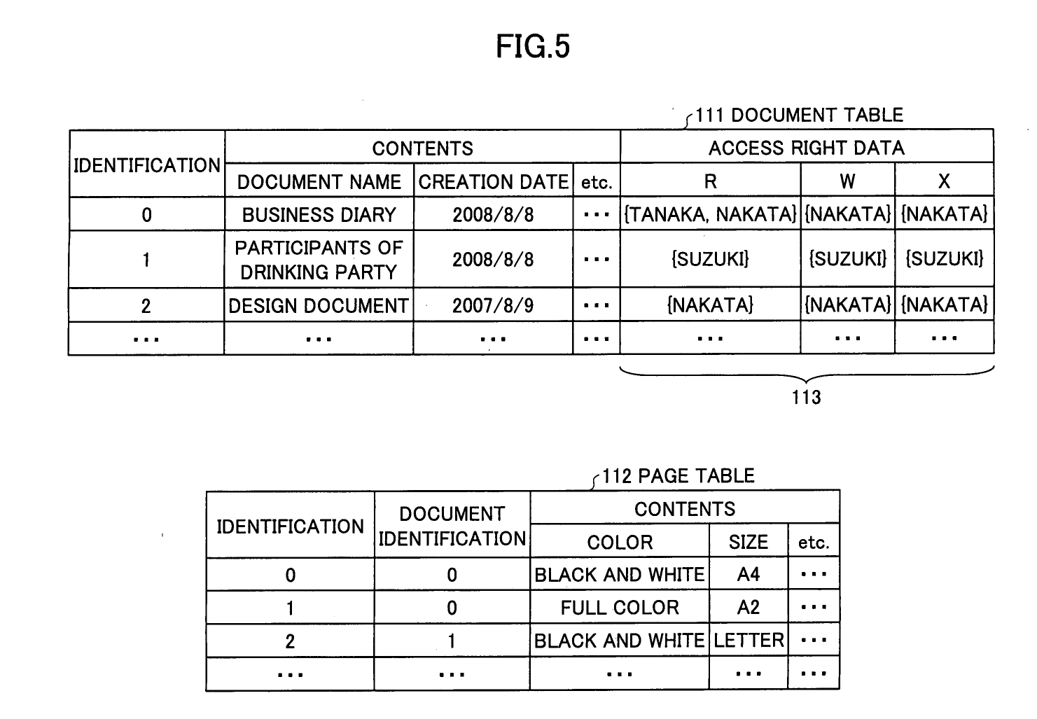

FIG. 5 is a diagram illustrating an example of a data structure of the database in the first implementation variation. In FIG. 5, each row of the document table 111 indicates one set of the document data, and each row of the page table 112 indicates one set of the page data.

The document table 111 manages data concerning items of identification, contents (bibliography information of a document name, creation date, and a like), and the access right data 113. As illustrated, the access right data 113 forms a column of the document table 111. In this configuration, the access right data 113 is included in the document data described with reference to FIG. 4.

In FIG. 5, a user name of a user possessing an operation right is registered for each type of operations (refer (R), write (W), and execute (X)). It should be noted that a configuration of the access right data 113 is not limited to the configuration illustrated in FIG. 5. For example, instead of for each user, the access control may be indicated with a role of the user. Alternatively, any one of various well-known configurations may be applied. The identification is used to identify each set of the document data A, B, and C.

On the other hand, the page table 112 manages identification, document identification, and contents (color, size, and a like of the bibliography information) for each set of the page data. The identification is used to identify each set of the page data. The document identification is used to identify the document data A, B, and C to which the page data belong. That is, by the document identification, it is possible to realize associating each set of page data with respective document data A, B, and C.

However, the access right data 113 are frequently used in searching for the document information or the like. Accordingly, if a recording location of the document table 111 including the access right data 113 is a recording medium which is accessible at higher speed than the page table 112, it is possible to easily realize a high-speed search.

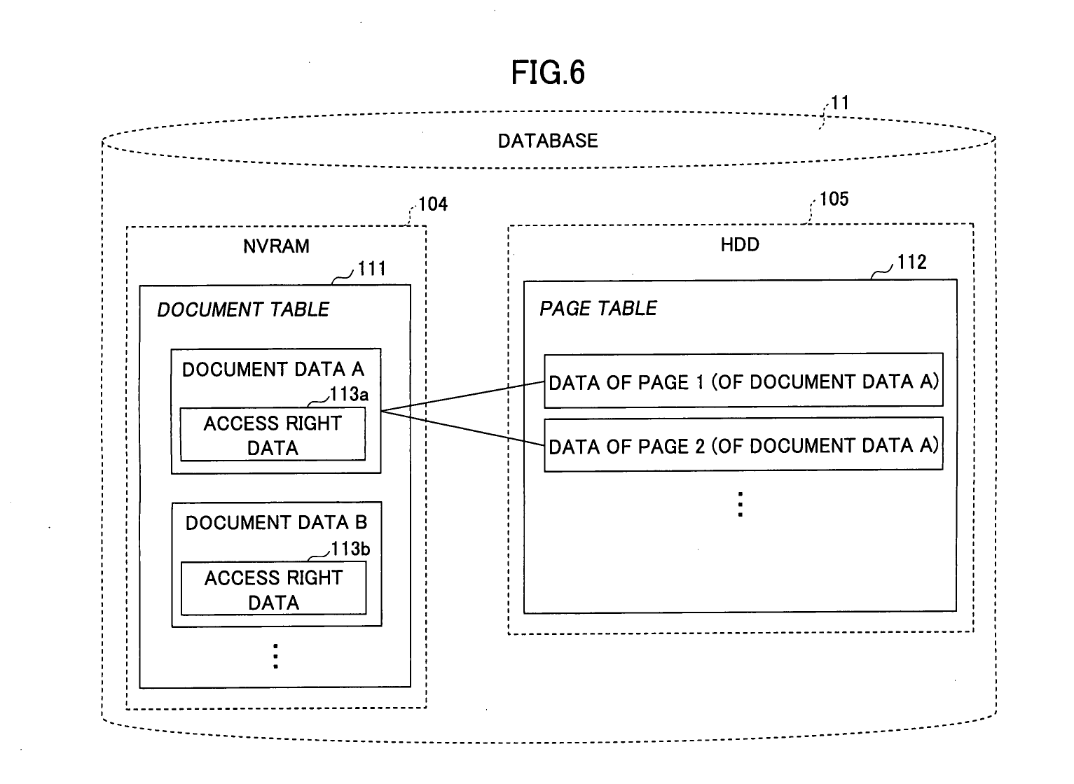

FIG. 6 is a diagram illustrating an example of recording the document table to the recording medium which is accessible at high speed in the first implementation variation. In the example in FIG. 6, the page table 112 is stored in the HDD 105, and the document table 111 is stored in the NVRAM 104 which is accessible at higher speed than the HDD 105. In general, an access speed affects a price of the recording medium. As shown in FIG. 6, instead of all tables forming the document information, only the document table 111 including the access right data 113 is stored in the recording medium which is accessible at the high speed. Accordingly, it is possible to reduce a storage space used in an expensive recording medium.

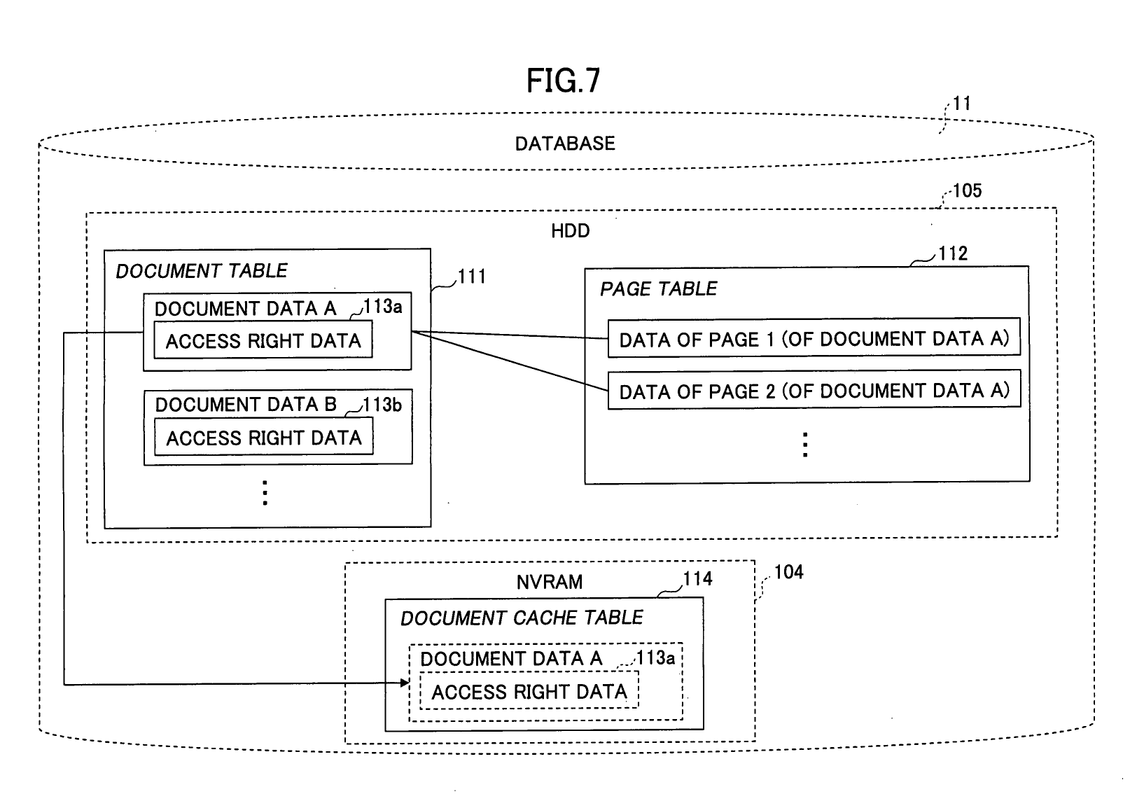

Moreover, in order to further save the area to use in the expensive recording medium, the following configuration may be applied. FIG. 7 is a diagram for explaining the document cache table in the first implementation variation.

In FIG. 7, the document table 111 and the page table 112 are stored in HDD 105. On the other hand, the document cache table 114 is formed in the NVRAM 104. The document cache table 114 is used to cache the document data to use (operate). In FIG. 7, the document data A is copied to the document cache table 114.

According to the configuration in FIG. 7, it is not required to store the entire document table 111 in the NVRAM 104, and higher access speed can be realized to the access right data 113 of the document data, which are frequently accessed. Accordingly, compared with the configuration in FIG. 6, it is possible to further save the area to use in the expensive recording medium. It should be noted that the document cache table 114 is not always formed in a non-volatile recording medium. For example, the document cache table 114 may be formed in the non-volatile RAM 103.

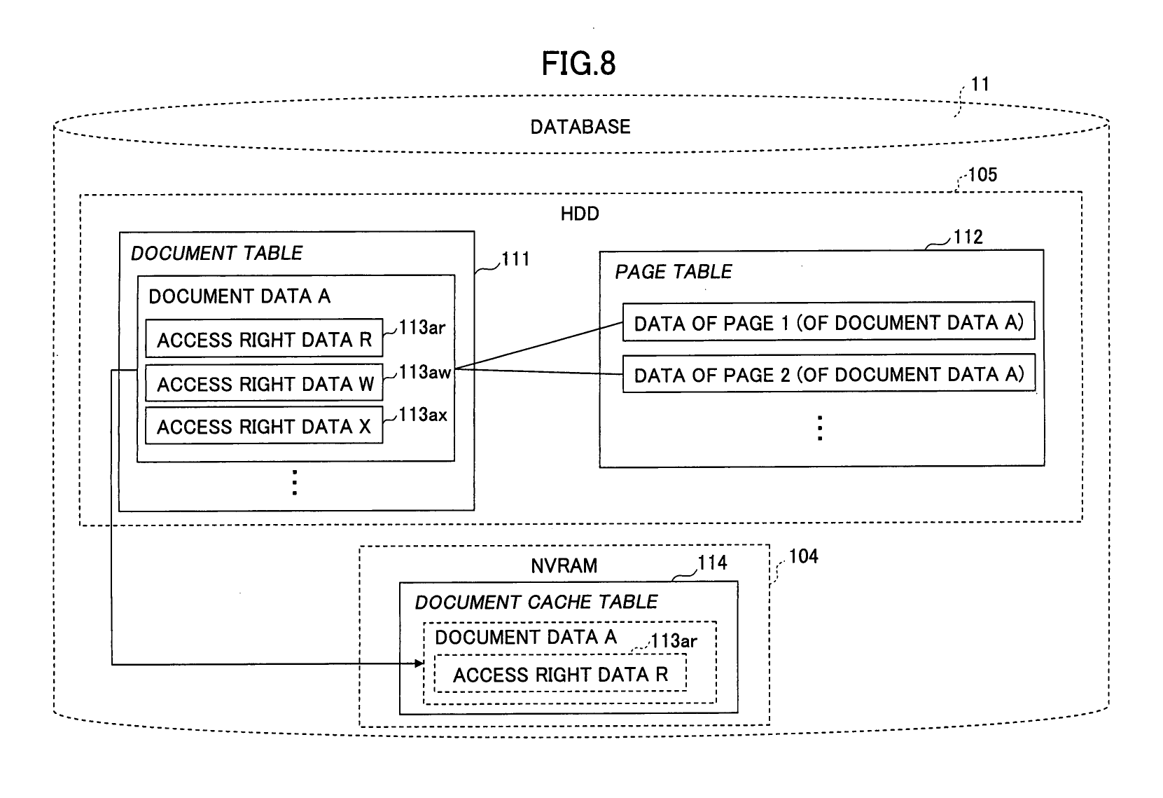

Moreover, in order to further save the area to use in the expensive recording medium, the following configuration may be applied. FIG. 8 is a diagram illustrating an example of recording only the access right data of a few of operation types to the document cache table in the first implementation variation.

In FIG. 8, similar to FIG. 7, the document table 111 and the page table 112 are stored in the HDD 105. The document cache table 114 is stores in the NVRAM 104. However, the document cache table 114 has a different configuration. That is, in FIG. 7, the access right data 113 concerning one set of the document data are divided into the types of operations, the document data are recorded in the document cache table 114 by its division unit. The document table 111 in FIG. 8 stores access right data R 113ar to refer, access right data W 113aw to write, and the access right data X 113ax, which are divided from the access right data 113a of the document data A. Also, as an example, the access right data R 113ar alone are recorded in the document cache table 114.

In general, in the access control information, information to refer to the document data A tends to be the most frequently accessed. Accordingly, by applying the configuration illustrated in FIG. 8, it is possible to realize higher access speed with respect to the most frequently accessed information, and it is possible to further save the area to use in the expensive recording medium.

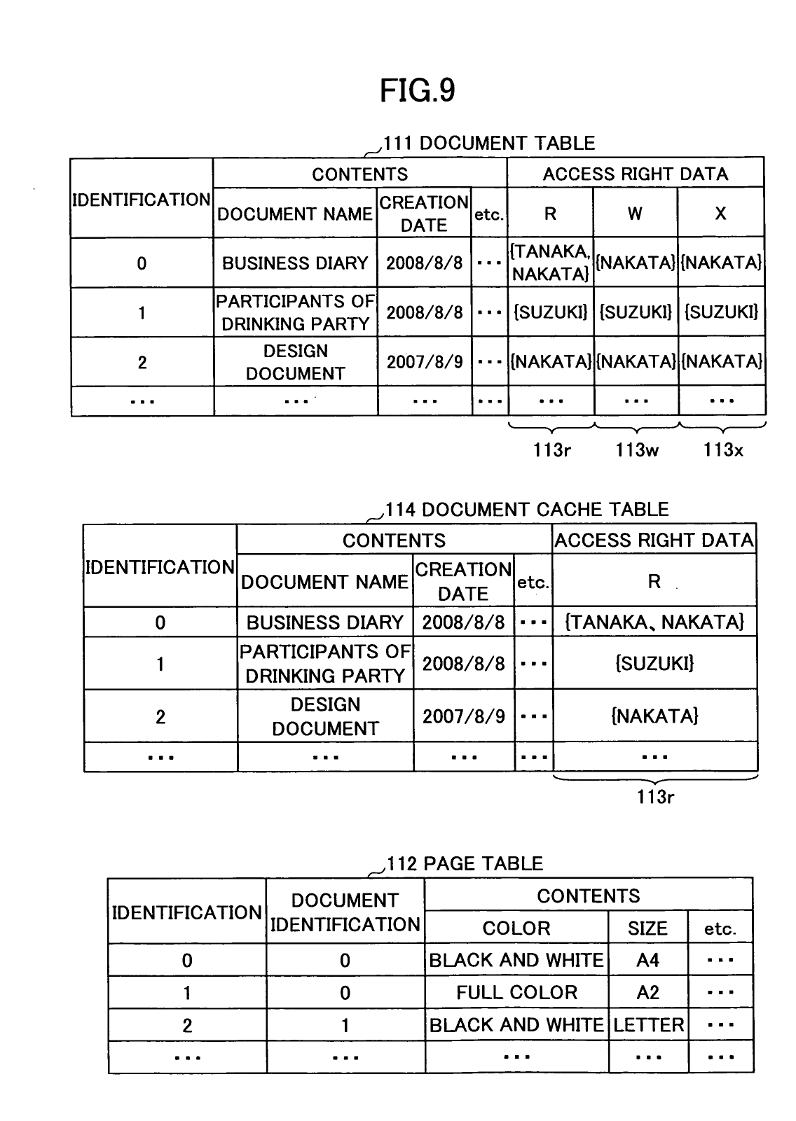

FIG. 9 is a diagram illustrating an example of a data structure of recording only the access right data of a few of operation types to the document cache table in the first implementation variation. That is, FIG. 9 illustrates a configuration example corresponding to the configuration in FIG. 8 for each table.

As illustrated in FIG. 9, the access right data 113 concerning all operation types are not recorded in the document cache table 114, and instead, only access right data 113r with respect to the refer (R) are recorded. The document table 111 and the page table 112 have the same configuration as illustrated in FIG. 5.

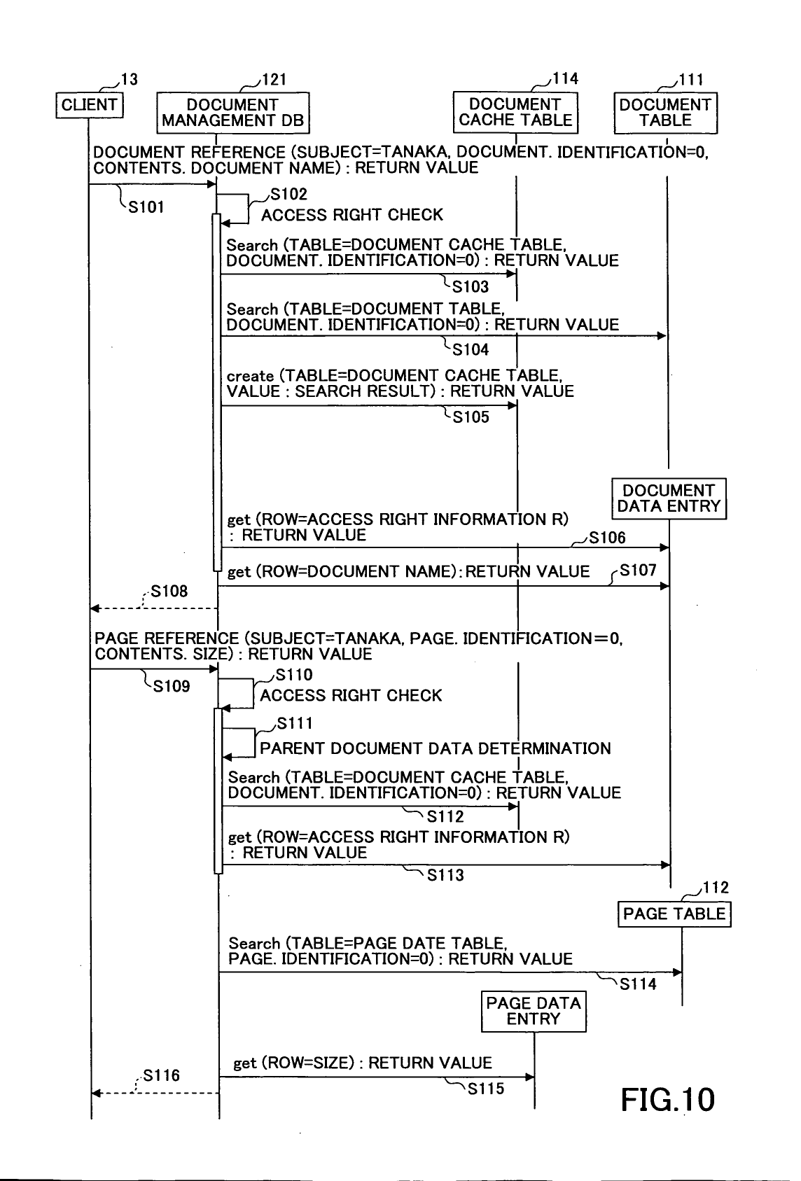

In the following, process steps of the image forming apparatus 10 in the first implementation variation will be described. FIG. 10 is a sequence diagram for explaining process steps when a data operation is requested in the first implementation variation.

When the client 13 requests an operation (refers to a document name) with respect to document data (identification=0), which is conducted by a login user (Tanaka) (S101), the document management DB 121 checks an access right with respect to this operation request (S102) In detail, the document management DB 121 conducts a search of the document data indicated as an operation subject with respect to the document cache table 114 (S103). When the document data are found, this process advances to step S106. When the document data are not found (not found in a cache), the document management DB 121 conducts the search similar to the step S103, with respect to the document table 111 (S104) Subsequently, the document management DB 121 creates a record of the document data being searched, to the document cache table 114 (S105). Then, the document data being searched are cached.

The process advances to step S106. In the step S106, the document management DB 121 acquires the access right data 113 corresponding to a requested operation type from the document data (hereinafter, called “current document data”) searched in the step S103 or the step S104, and determines presence or absence of a right of the operation for the login user. If the login user has the right for the operation, the document management DB 121 conducts the operation (refers to the document name) with respect to the current document data (S107), and returns an operation result to the client 13 (S108).

Subsequently, when the client 13 requests an operation (refers to the size) to page data (identification=0) which belongs to the current document data, which is conducted by the login user (Tanaka) (S109), the document management DB 121 checks the access right for this operation request (S110). In detail, the document management DB 121 determines identification of parent document data to which page data belongs, by searching for document identification of the page data being the operation subject (S111).

Subsequently, the parent document data are searched for with respect to the document cache table 114 (S112). As illustrated in FIG. 10, in a case in that the parent document data has already been searched for, the parent document data can be searched for from the document cache table 114 at high possibility. However, if the search in the step S112 fails, the parent document data may be searched from the document table 111.

Subsequently, the document management DB 121 acquires the access right data 113 corresponding to the requested operation type from a searched parent document data, and determines presence or absence of a right of the operation which is conducted by the login user (S113). The document management DB 121 determines presence or absence of the right with respect to page data to which belongs to the parent document data, based on the presence or absence of the right to the parent document data. Accordingly, the access right data 113 for the parent document data are applied to the page data.

If the right of the operation is given to the parent document data, the document management DB 121 searches for page data indicated as an operation subject with respect to the page table 112 (S114). Subsequently, the document management DB 121 conducts the operation (refers to the size) to searched page data (S115), and returns an operation result to the client 13 (S116).

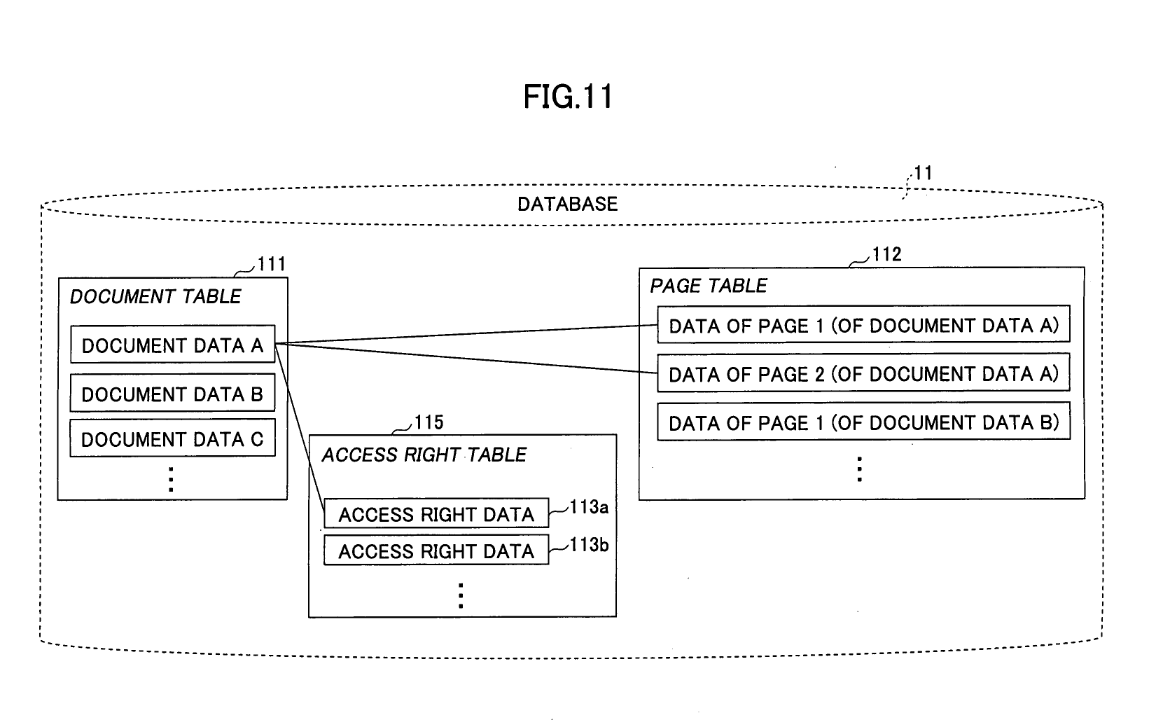

Next, a second implementation variation of the databases will be described. FIG. 11 is a diagram illustrating a configuration example of the database in the second implementation variation. As illustrated in FIG. 11, in the second implementation variation, the access right data 113 is managed by associating with corresponding document data in the access right table 115 which is different from the document table 111.

In the second implementation variation, advantageously, it is not required to define a schema for storing the access right data 113 for each of the semantics DB 12. In detail, it is possible for the document management DB 121 and the account management DB 122 to use the same access right table 115. Moreover, even if it is not possible to use the access right table 115 having the same contents, it is possible to use the access right table 115 having the same configuration.

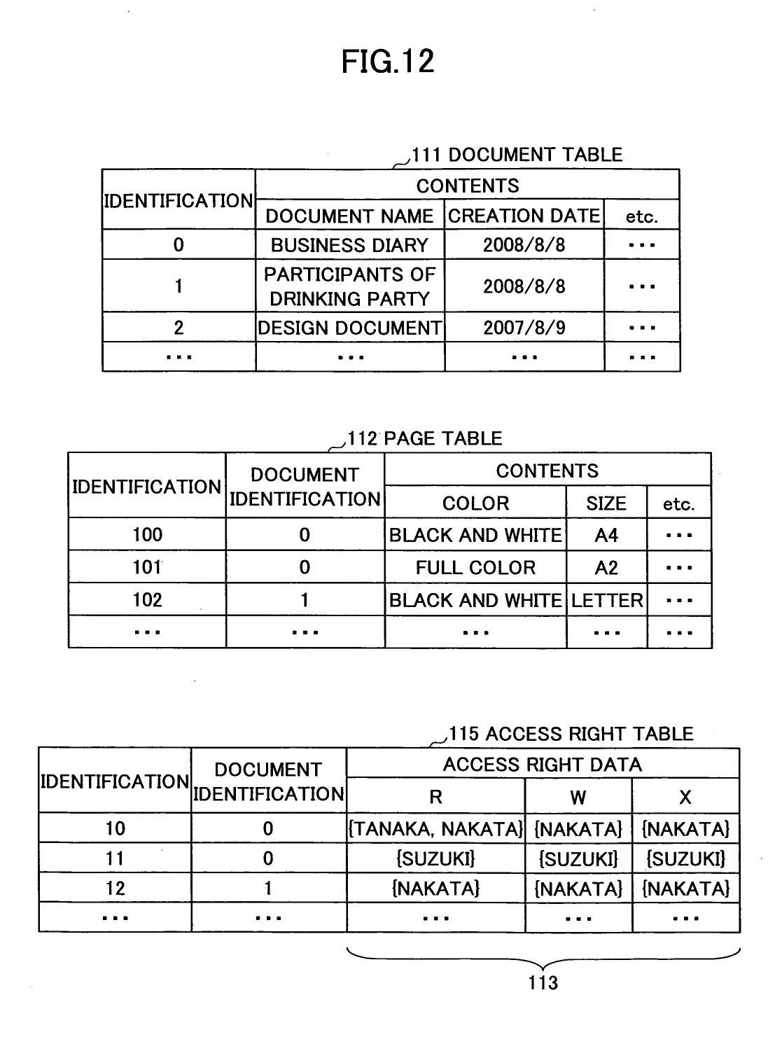

FIG. 12 is a diagram illustrating example of a data structure in the database of the second implementation variation.

In FIG. 12, the document table 111 does not include a column of the access right data 113. The page table 112 is the same as that in the first implementation variation. The access right table 115 manages identification, document identification, and a like for each set of the access right data 113. The identification is used to identify each set of the access right data 113. The document identification is used to identify the document data corresponding to the access right data 113. That is, it can be realized to associate each set of access right data 113 with the document data by using the document identification.

In FIG. 12, an example is illustrated in that relations from the access right data 113 to the document data. Accordingly, the page data are indirectly associated with the access right data 113 through the document data. It may be possible to maintain identification of the page data in the access right table 115. Also, in the document table 111 and the page table 112, identification for the access right data 113 may be maintained. Thereby, it is possible to realize bidirectional association.

Moreover, if a recording location of the access right table 115 including the access right data 113 is a recording medium which is accessible at higher speed than the document table 111 and the page table 112, it is possible to easily realize a high-speed search.

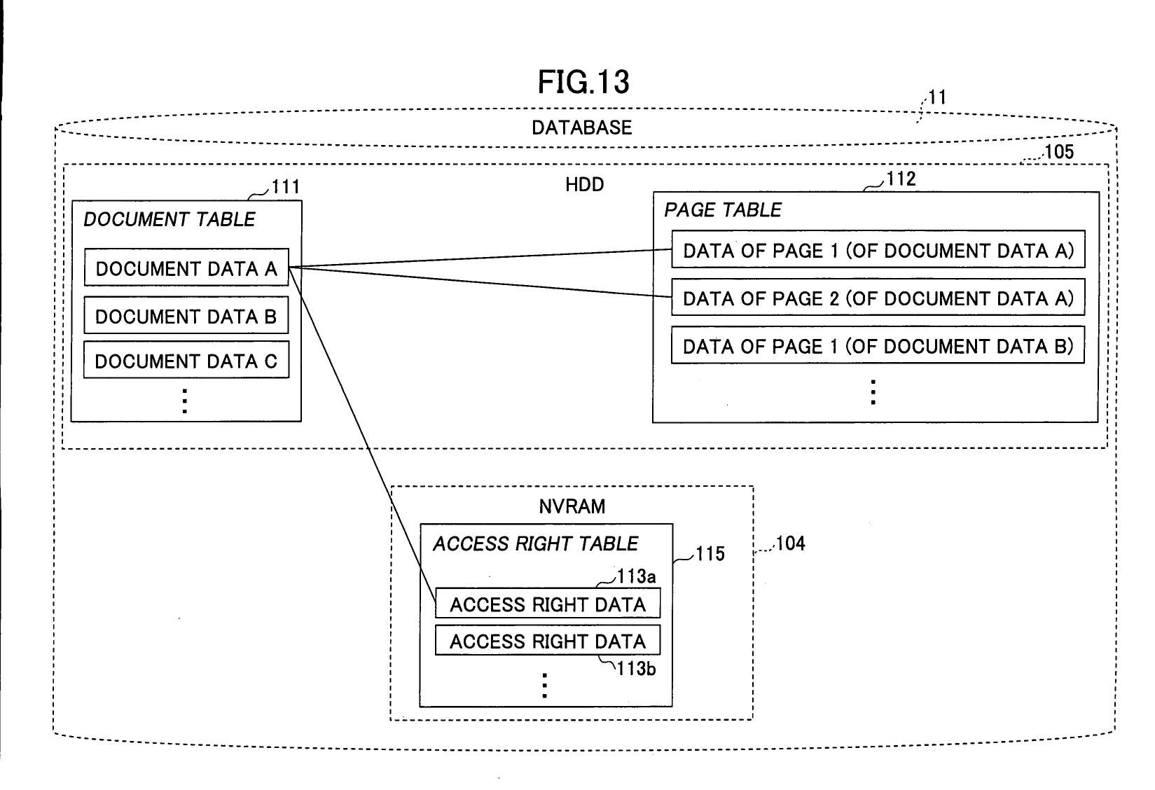

FIG. 13 is a diagram illustrating an example of recording the access right table to the recording medium which is accessible at high speed in the second implementation variation. In the example in FIG. 13, the document table 111 and the page table 112 are stored in the HDD 105, and the access right table 115 is stored in the NVRAM 104 which is accessible at higher speed than the HDD 105. By this configuration, it is possible to obtain the same effect as the configuration in FIG. 7. Moreover, in the second implementation variation, since the access right data 113 is separated from the document data, it is possible to reduce the storage space used in the recording medium more than the configuration in FIG. 7.

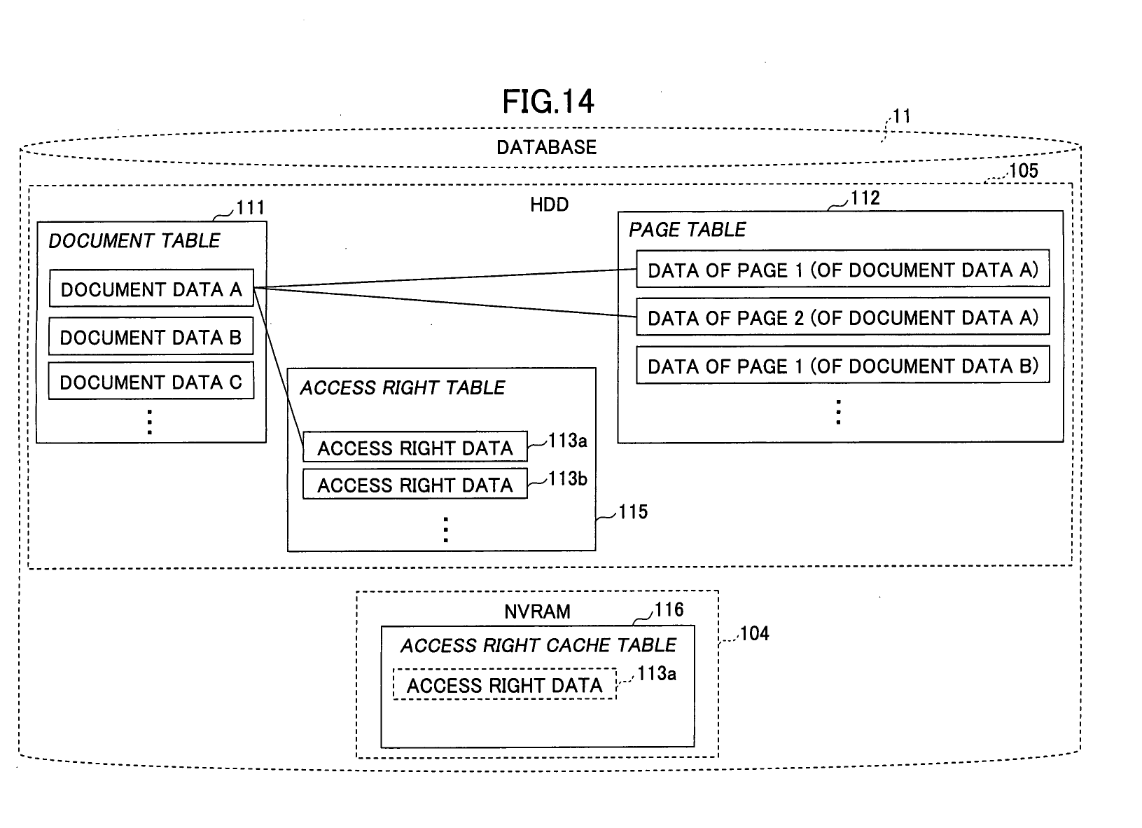

Moreover, in order to further reduce the storage space used in the expensive recording medium, the following configuration may be applied. FIG. 14 is a diagram for explaining the access right cache table in the second implementation variation.

In FIG. 14, the document table 111, the page table 112, and the access right table 115 are stored in the HDD 105. On the other hand, an access right cache table 116 is formed in the NVRAM 104. The access right cache table 116 is used to cache the access right data 113 which is used (operated). In the example in FIG. 14, the access right data 113a is copied to the access right cache table 116.

According to the configuration, it is not required to store the entire contents of the access right table 115 in the NVRAM 104, and higher access speed can be realized to the access right data 113 of the document data, which are frequently accessed. Accordingly, compared with the configuration in FIG. 6, it is possible to further reduce the storage space used in the expensive recording medium. It should be noted that the access right cache table 116 is not always formed in a non-volatile recording medium. For example, the access right cache table 116 may be formed in the non-volatile RAM 103.

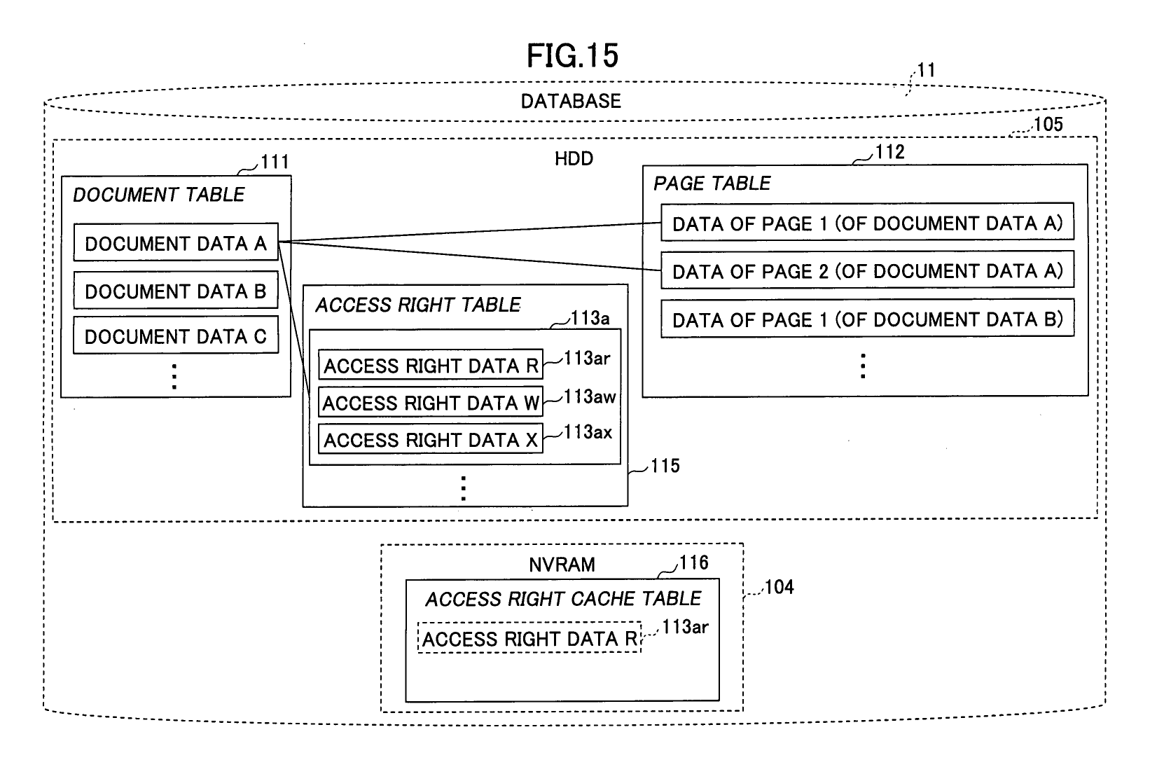

Moreover, in order to further reduce the storage space used in the expensive recording medium, the following configuration may be applied. FIG. 15 is a diagram illustrating an example of recording only the access right data of a few of operation types to the access cache table in the second implementation variation.

In FIG. 15, similar to FIG. 14, the document table 111, the page table 112, and the access right table 115 are stored in the HDD 105. The access right cache table 116 is stored in the NVRAM 104. However, the access right cache table 116 has a different configuration. That is, in FIG. 14, similar to FIG. 8, the access right data 113 are divided into the types of operations, the access right data 113 are recorded in the access right cache table 116 by its division unit. The access right cache table 116 in FIG. 15 stores access right data R 113ar to refer, access right data W 113aw to write, and the access right data X 113ax.

Accordingly, by applying the configuration illustrated in FIG. 15, it is possible to realize higher access speed with respect to the most frequently accessed information, and it is possible to further reduce the storage space used in the expensive recording medium.

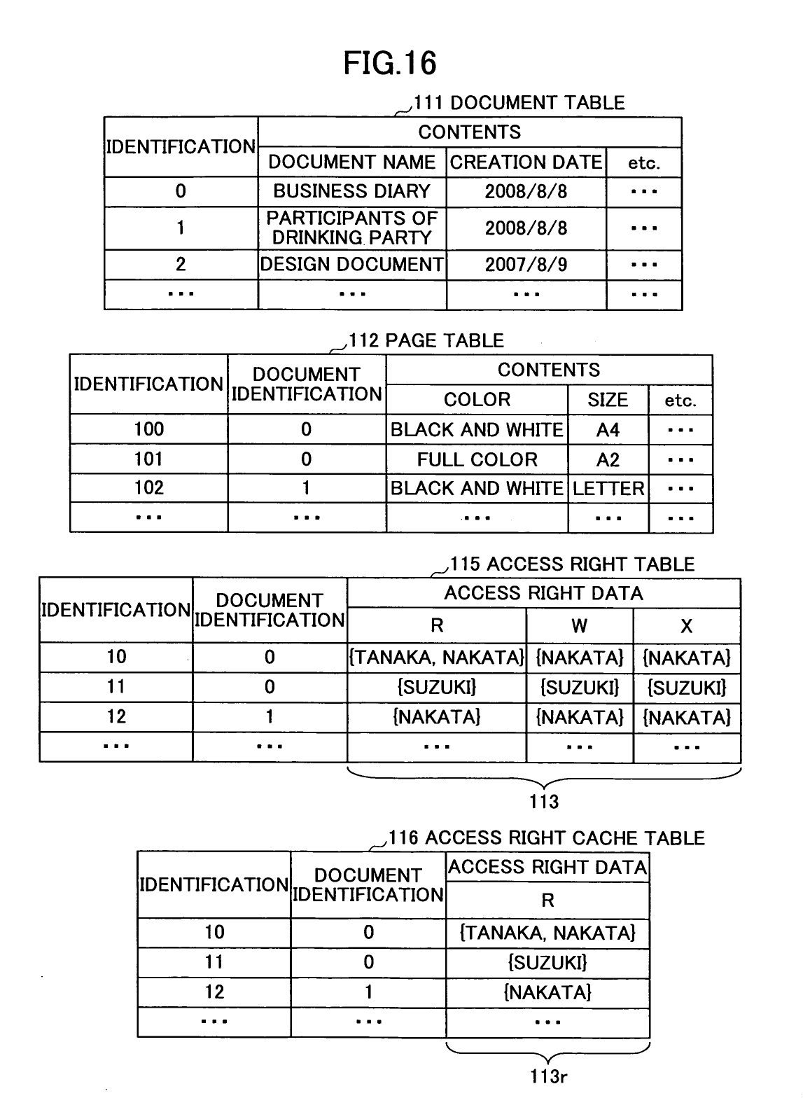

FIG. 16 is a diagram illustrating an example of a data structure of recording only the access right data of a few of operation types to the access right cache table in the second implementation variation. That is, FIG. 16 illustrates a configuration example corresponding to the configuration in FIG. 15 for each table.

As illustrated in FIG. 16, the access right data 113 concerning all operation types are not recorded in the access cache table 116, and instead, only access right data 113r with respect to the refer (R) are recorded. The document table 111, the page table 112, and the access right table 115 have the same configuration as illustrated in FIG. 12.

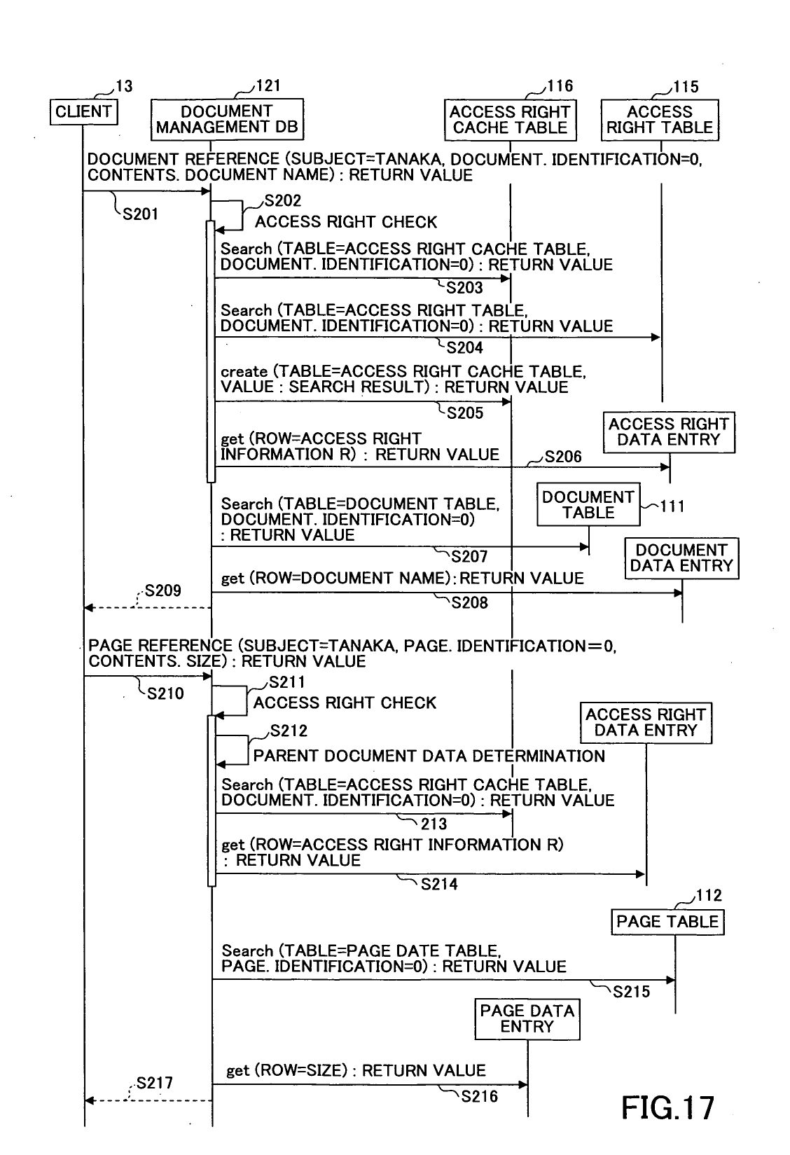

In the following, process steps of the image forming apparatus 10 in the second implementation variation will be described. FIG. 17 is a sequence diagram for explaining process steps when a data operation is requested in the second implementation variation.

When the client 13 requests an operation (refers to a document name) with respect to document data (identification=0), which is conducted by a login user (Tanaka) (S201), the document management DB 121 checks an access right with respect to this operation request (S202) In detail, the document management DB 121 conducts a search of the document data indicated as an operation subject with respect to the access right cache table 116 (S203). When the access right data 113 are found, this process advances to step S206. When the access right data 113 are not found (not found in a cache), the document management DB 121 conducts the search similar to the step S203, with respect to the access right table 115 (S204). Subsequently, the document management DB 121 creates a record of the access right data 113 being searched, to the access right cache table 116 (S205). Then, the access right data 113 being searched are cached.

The process advances to step S206. In the step S206, the document management DB 121 acquires the access right data corresponding to a requested operation type from the access right data 113 (hereinafter, called “current access right data”) searched in the step S203 or the step S204, and determines presence or absence of a right of the operation for the login user. If the login user has the right of the operation, the document management DB 121 searches for the document data indicated as an operation subject, from the document table 111 (S207). Subsequently, the document management DB 121 conducts the operation (refers to the document name) with respect to the searched document data (S208), and returns an operation result to the client 13 (S209).

Operations to the page data in steps S210, S211, S212, S213, S214, S215, S216, and S217 are the same as operations in the steps S109, S110, S111, S112, S113, S114, S115, and S116 in FIG. 10, and the explanations thereof are omitted. However, by conducting the steps S210 through S217, instead of the document data stored in the document cache table 114, presence or absence of the access right for the page data is determined based on the access right data 113 stored in the access right cache table 116.

In the first implementation variation and the second implementation variation, it is configured to cache the access right data 113. However, a memory area for the cache is limited. In order to appropriately hit the cache at high possibility, it is required to properly determine selecting the access right data 113 to delete from a cache area. In the following, a method for deleting the access right data 113 which has cached will be described in a third implementation variation of the databases. In the third implementation variation, different portions from the second implementation variation will be explained.

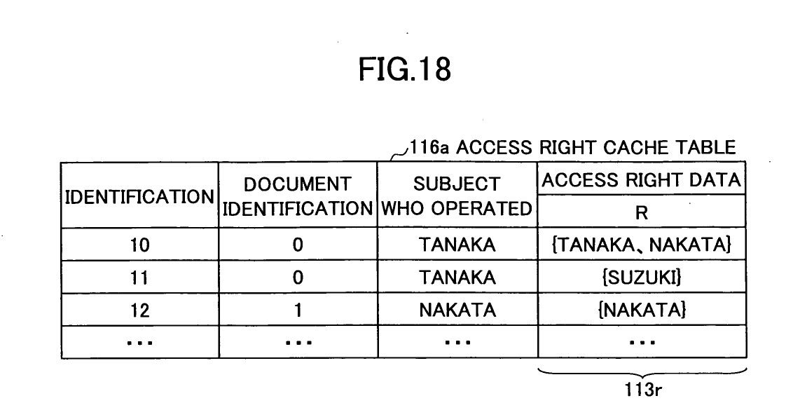

FIG. 18 is a diagram illustrating a configuration example of the access right cache table in the third implementation variation. Different from the above-described implementation variations, in the third implementation variation, the access right cache table 116a further manages a subject who operated, for each access right cache data 114r.

For example, in the step S204 in FIG. 17, when the access right data 113 is registered to the access right cache table 116a, a user name of a user concerning an operation request is registered as the subject who operated. That is, the subject who operated is a subject (user) concerning an operation by which the access right data 113 is stored in the cache. For example, the access right data R 113r of identification “10” is registered to the access right cache table 116a in response to the operation by a user of a user name “TANAKA”.

The subject who operated in the access right cache table 116a is used, when deleting the access right data R 113r, which becomes unnecessary at high possibility, from the access right cache table 116a.

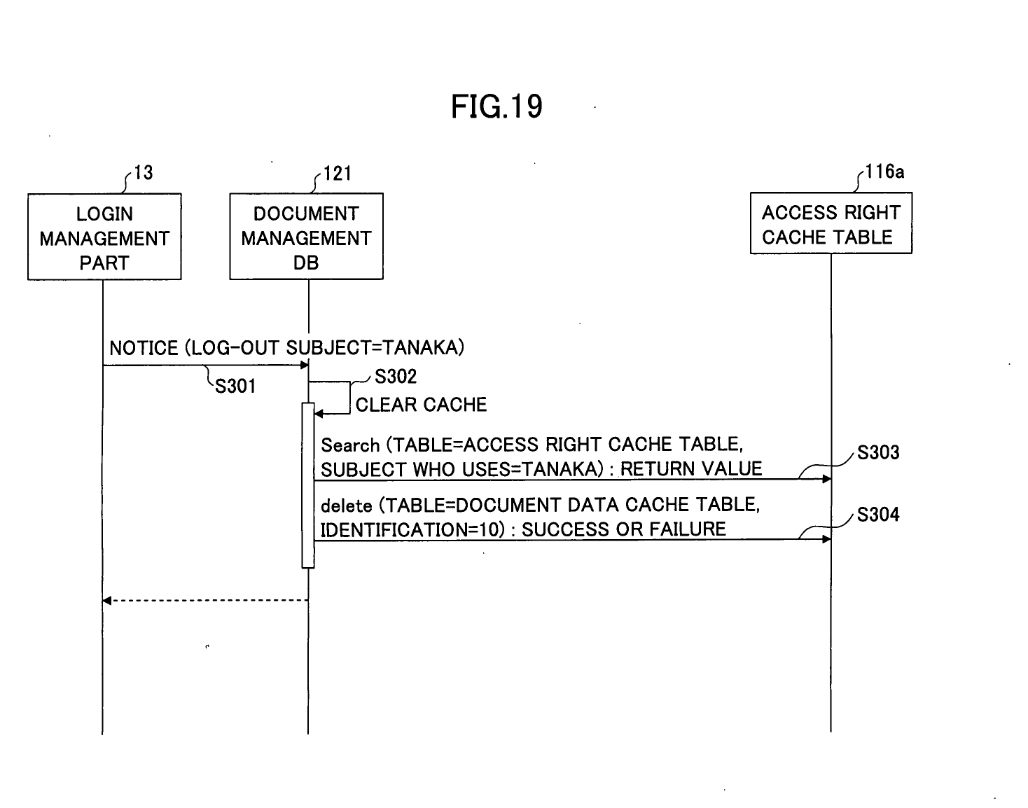

FIG. 19 is a sequence diagram for explaining an entry deletion process for deleting from the access right cache table in the third implementation variation.

When the login management part 13 detects a logout (end of an operation) of a user, the user name of the user who logged out is informed to the document management DB 121 (S301). The document management DB 121 conducts a process for deleting the access right data 113r, which becomes unnecessary at high possibility, from the access right cache table 116a in response to the logout (S302).

In detail, the document management DB 121 searches for the access right data 113r in which the subject who operated is the same as the user name concerning the logout, from the access right cache table 116a (S303). Subsequently, the document management DB 121 deletes the searched access right data 113r from the access right cache table 116a (S304).

That is, a method for clearing the cache in the third implementation variation is based on experiences in that the document data subject to use is different corresponding to a user at highly possibility. In detail, in many cases, a user of document data is a creator of the document data. In addition, in many cases, the user of the document data is a person working in the same group as the creator. In the third implementation variation, when a certain user logs out (a utilization state of the user is released), the access right data 113r in which the user is the subject who operated are deleted from access right cache table 116b. According to this configuration, it is possible to properly select the access right data 113r as a deletion subject from the access right cache table 116b.

Alternatively, the method for clearing the cache may be combined with a well-known algorithm (FIFO (First-In First-Out)), an LRU (Least Recently Used), or a like. In the third implementation variation, the access right cache table 116 is illustrated. Alternatively, in the same manner, a subject who operated may be recorded for the document cache table 114, and the document data may be deleted simultaneously when a user logs out.

Moreover, the cache may be formed with multi-levels. In detail, a cache table is formed with multi-levels depending on an access speed of a recording medium, and the access right data 113, which are pushed out in accordance with an algorithm such as the FIFO, the LRU, or the like, are moved to a recording medium of slower access speed level by level. When the logout occurs, the access right data 113 in which the subject who operated is the same as the user name concerning the logout are deleted.

According to the present invention, it is possible to provide an image forming apparatus and an access control method, which effectively manage and use the access control information.

The present invention is not limited to the specifically disclosed embodiments, and variations and modifications may be made without departing from the scope of the invention.

The present application is based on the Japanese Priority Patent Application No. 2008-054818 filed Mar. 5, 2008, the entire contents of which are hereby incorporated by reference.

What is claimed is:

1. An image forming apparatus, comprising:
a first data management part configured to manage a list of first data concerning information regarded as a management unit;
a second data management part configured to manage a list of second data concerning accompanying information which accompanies with the information regarded as the management unit; and
a determination part configured to determine allowing or denying an operation request based on access control information recorded in a first recording medium associating with the first data with which the second data accompanies, in response to the operation request with respect to the second data.

2. The image forming apparatus as claimed in claim 1, wherein the determination part is configured to record the access control information used to determine allowing or denying the operation request to a second recording medium accessible at higher speed than the first recording medium, by associating with the first data.

3. The image forming apparatus as claimed in claim 2, wherein the determination part is configured to record only information corresponding to an operation type in the access control information which is used to determine allowing or denying the operation request, to the second recording medium.

4. The image forming apparatus as claimed in claim 2, wherein in response to the operation request with respect to the first data or the second data, the determination part is configured to determine allowing or denying an operation request based on the access control information, which is stored in the second recording medium by associating with the first data subject to be operated or the first data with which the second data is accompanied.

5. The image forming apparatus as claimed in claim 4, wherein the determination part is configured to determine allowing or denying the operation request based on the access control information stored in the first recording medium, when the access control information associating with the first data subject to be operated or the first data with which the second data accompanies.

6. The image forming apparatus as claimed in claim 2, wherein the determination part is configured to store the access control information used to determine allowing or denying the operation request by associating with identification of a subject of the operation request in the second recording medium, and delete the access control information associating with the identification of the subject from the second recording medium in response to a notice of an operation end of the subject.

7. An access control method conducted by the image forming apparatus, said image forming apparatus comprising: a first data management part configured to manage a list of first data concerning information regarded as a management unit; and a second data management part configured to manage a list of second data concerning accompanying information which accompanies with the information regarded as the management unit, said access control method comprising:
determining allowing or denying an operation request based on access control information recorded in a first recording medium associating with the first data with which the second data accompanies, in response to the operation request with respect to the second data.

8. The access control method as claimed in claim 7, further comprising recording the access control information used to determine allowing or denying the operation request to a second recording medium accessible at higher speed than the first recording medium, by associating with the first data.

9. The access control method as claimed in claim 8, wherein in said recording the access control information, only information corresponding to an operation type in the access control information which is used to determine allowing or denying the operation request, is recorded to the second recording medium.

10. The access control method as claimed in claim 8, wherein in said determining allowing or denying the operation request, it is determined to allow or deny an operation request based on the access control information, which is stored in the second recording medium by associating with the first data subject to be operated or the first data with which the second data is accompanied, in response to the operation request with respect to the first data or the second data.

11. The access control method as claimed in claim 8, wherein in said determining allowing or denying the operation request, it is determined to allow or deny an operation request based on the access control information stored in the first recording medium, when the access control information associating with the first data subject to be operated or the first data with which the second data accompanies.

12. The access control method as claimed in claim 8, wherein in said recording the access control information, the access control information used to determine allowing or denying the operation request is stored by associating with identification of a subject of the operation request in the second recording medium, and
said access control method further comprises deleting the access control information associating with the identification of the subject from the second recording medium in response to a notice of an operation end of the subject.
